(19) United States
(12) Patent Application Publication
(10) Pub. No.: US 2016/0107578 A1
(43) Pub. Date: Apr. 21, 2016

(54) METHOD OF SELECTING MIRRORS FOR ADJUSTMENT

(71) Applicant: Continental Automotive Systems, Inc., Auburn Hills, MI (US)

(72) Inventors: Zachary J. Bolton, Birmingham, MI (US); Brian R. Saloka, Harrison Township, MI (US); Jean-Christophe L. Deniau, Fenton, MI (US)

(73) Assignee: CONTINENTAL AUTOMOTIVE SYSTEMS, INC., Auburn Hills, MI (US)

(21) Appl. No.: 14/515,100

(22) Filed: Oct. 15, 2014

(51) Int. Cl. B60R 1/02

(52) U.S. Cl. CPC B60R 1/025

(57) ABSTRACT

A mirror adjustment system is provided including a switch to allow a vehicle operator to provide input to adjust a rearview mirror. A sensory system is provided to determine which mirror the driver intends to adjust. A controller is provided which is cognizant of a driver's intended mirror and causes the intended mirror to respond to the driver's switch input.

### FIELD OF THE INVENTION

The present invention relates to automotive rearview mirrors and methods of adjustment thereof.

### BACKGROUND OF THE INVENTION

In the chronicles of automotive safety history, the earliest known use of a rearview mirror in an automotive vehicle appeared on Ray Harroun's racecar in the inaugural Indianapolis 500 race in 1911. To maximize the benefit provided by rearview mirrors, virtually all rearview mirrors are now adjustable. In the most recent decade, most premium automotive vehicles now have rearview mirrors with power adjustment allowing the vehicle operator to utilize an electrical switch to adjust the rearview mirrors. Before adjusting the position of a driver's side (left in North America, right in England and Africa) or passenger side mirror, the driver has to select which mirror needs to be adjusted. The selection of which mirror requires adjustment is often accomplished via a switch with three position; right, neutral, and left. The neutral position is the one wherein no mirror is selected to prevent any incidental adjustments.

Three position switches are generally expensive, add weight to the motor vehicle, as well as complexity and also provide additional failure modes. In addition in most motor vehicles, the side mirror controls are on the driver's left side armrest. This location is subject to vibration (when the door is slammed or closed) and potential moisture (when the vehicle window is left open or when the weather seals wear off). It is desirable to provide a window adjustment system wherein a switch would not have to be provided which additionally has the function of mirror selection but can simply be utilized for adjustment function therefore reducing its complexity, weight, and enhancing its reliability.

### SUMMARY OF THE INVENTION

To make manifest the above noted and other manifold desires, a revelation of the present invention is brought forth. In one of many preferred embodiments, the present invention brings forth a system and method of utilization thereof for adjusting multiple rearview mirrors in an automotive vehicle. The system includes a switch to allow a vehicle operator to provide input to adjust a rearview mirror. A sensory system is provided to determine which mirror the driver intends to adjust. A controller is provided which is cognizant of a driver's intended mirror and causes the intended mirror to respond to the driver's switch input.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side elevational view of an automotive vehicle which can utilize the rearview mirror adjusting system of the present invention;

FIG. 2 is a perspective of a driver inside an automotive vehicle with a rearview mirror adjusting system according to the present invention;

FIG. 3 is top elevational schematic view with portions of a vehicle roof being removed for clarity of illustration illustrating a vehicle with the mirror adjusting system according to the present invention;

FIG. 4 is a schematic view illustrating a vehicle driver looking towards a passenger side rearview mirror;

FIG. 5 is a schematic view of a driver looking toward a driver's side rearview mirror; and

FIG. 6 is a perspective view of a rearview mirror utilized on a larger vehicle having distant and close rearview mirrors utilizing the mirror adjustment system of the present invention.

### DETAILED DESCRIPTION OF THE PREFERRED EMBODIMENTS

The following description of the preferred embodiment(s) is merely exemplary in nature and is in no way intended to limit the invention, its application, or uses.

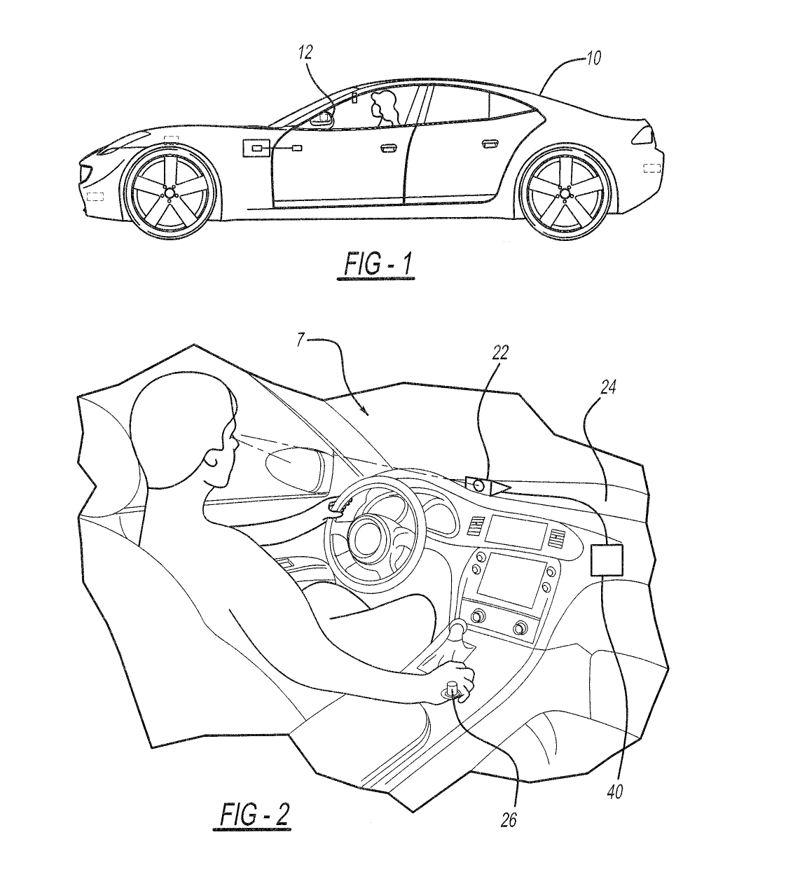

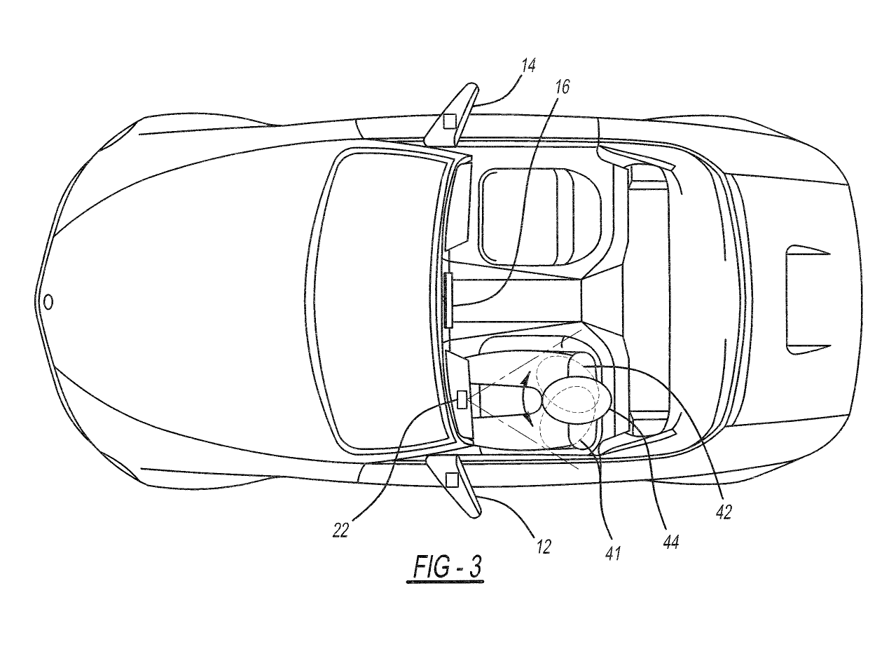

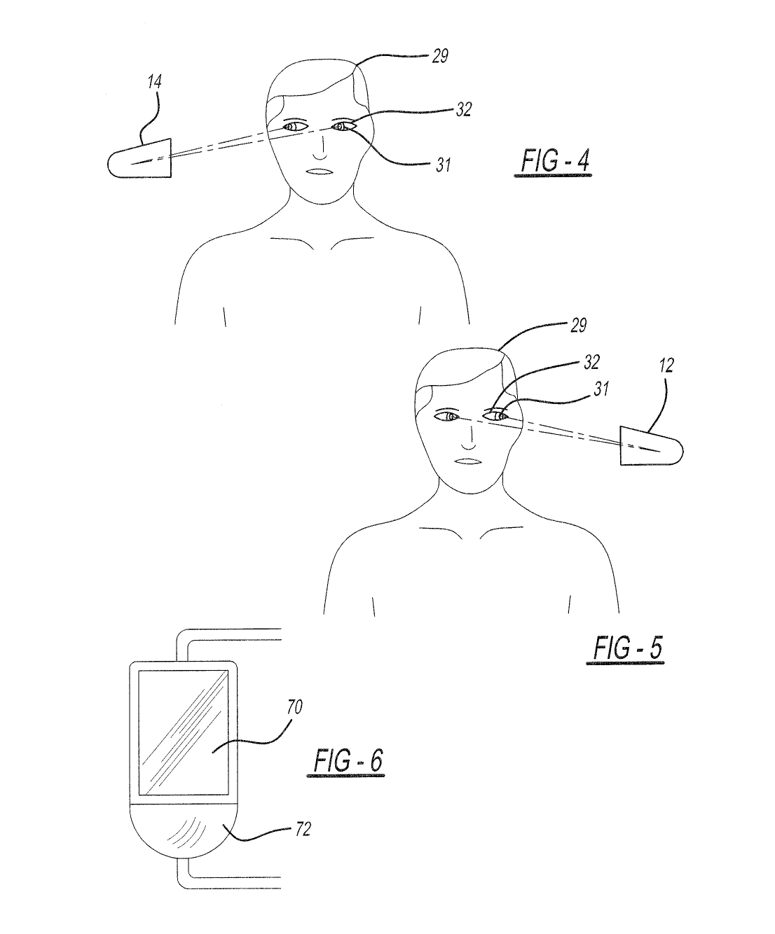

Referring to FIGS. 1-6, a system 7 for adjusting rearview mirrors is provided. Virtually all automotive vehicles in production today have a driver side rearview mirror 12. As will be apparent to those skilled in the art, the driver's side rearview mirror is typically on the left side of the vehicle in North America; however, it is on the right side of a vehicle for use in the United Kingdom, southern Africa, or Japan. Virtually all vehicles now have passenger side rearview mirrors 14. Virtually all passenger automotive vehicles are also supplied with an interior rearview mirror 16. The rearview mirror adjusting system 7 of the present invention includes a switch 20. The switch 20 is typically a toggle like switch which allows for adjustment of the rearview mirrors about a vertical axis and about an X axis, the X axis being typically transverse to the major axis of the vehicle. The mirror adjusting system 7 includes a driver sensor 22 shown in FIG. 2 being mounted on a dashboard panel 24. The sensory system 22 records a driver's head 29 and head position, eye position including pupil 31 and sclera 32, and other facial feature positions and information to a vehicle controller 40. The sensory system 22 can be a monocular camera, binocular camera, or an array of cameras, or another type of sensing device capable of providing information functional to determine the director of a driver's gaze or focus. The controller 40 typically includes a memory. The sensory system determines the driver intended rearview mirror to adjust. If the driver moves their head to the position 41 (shown in phantom), the sensory system will determine that the driver intends to adjust the driver's side rearview mirror 12. As a driver moves their head to the position shown in 42, the sensory system will determine if driver intends to adjust the passenger side external rearview mirror 14. If the driver holds their head to the position shown in 44, the system will further look at the relationship between the pupil of the eye and the sclera to determine what the driver is looking at the driver side external rearview mirror 12, the interior rearview mirror 16, or the passenger side rearview mirror 14.

The system 7 can be enhanced by further having a facial recognition system. The recognition system can take its data from an onboard storage, an external data source which is plugged in by the vehicle operator, or from the cloud. The recognition system, upon recognizing a previous driver, will automatically adjust some or all of the mirrors to the position wherein they were in when the driver last utilized the vehicle. This feature is very useful in situations where more than one person often utilize the same vehicle and have different preferred adjustment locations. In another embodiment, the recognition system is also be utilized for situations wherein a new driver utilizes the vehicle, such as a rental car, that the system places the rearview mirrors in suggested best positions based upon the head position of vehicle driver. This adjustment occurs even upon start up of the vehicle without the vehicle operator utilizing the switch. Also on suggested positions for vehicle driver, the controller is made cognizant not only of the driver's head position, or the driver's pupil with relationship to the rest of the sclera, but is also made aware of the driver's seat position forward or rearward, the base seat height, base seat tilt, or the tilt of the seat back to attempt to optimize the suggested rearview mirror positions. Another alternate feature of the mirror adjustment system is that there is a USB port 57 placed in the vehicle to allow the vehicle operator to tell the vehicle their prior preferred mirror adjustment positions. This feature is highly useful for frequent travelers when utilizing rental vehicles and saves the vehicle traveler of readjusting all of the rearview mirrors.

FIG. 6 illustrates a multiple rearview mirror arrangement for large scale vehicles such as trucks in classes 7 and 8 wherein there is often a far distance rearview mirror 70 and a secondary rearview mirror 72 to give the truck driver better views of vehicles which may be in the truck's blind spot. Again, typically such systems require a determination of eye focus since head position will be essentially the same for both mirrors.

In operation a driver starts the vehicle. The sensory system 22 informs the controller 40 of the identity of the driver, head position and eye focus from a determination from the eyes pupil location. If the driver is known, the controller 40 adjusts the rearview mirrors to the driver's prior selected position. If the driver is new to the vehicle, the controller adjusts the rearview mirrors to a suggested position based upon drivers head position and seat position. If suggested adjusted position is unsatisfactory to the driver, upon the drivers contact with the switch 20 the sensory system determines the rearview mirror the driver intends to adjust. The controller 40 is made cognizant of the driver intended mirror, and then selects that mirror to respond to the switch input. The driver's facial features and mirror adjusted positions are them stored in a memory onboard, or into a driver's memory key, or into a cloud for future use.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A system to adjust rearview mirrors in an automotive vehicle comprising:
a switch responsive to a vehicle operator's input for adjusting a rearview mirror;
a sensory system for determining a driver intended mirror to adjust; and
a controller cognizant of driver intended mirror to adjust, said controller selecting the mirror to adjust causing said mirror to respond to said switch input

2. The system of claim 1 wherein said controller selects adjustment of driver's side external rearview mirror and a passenger side external rearview mirror.

3. The system of claim 2 wherein said system also controls adjustment of an interior rearview mirror.

4. The system of claim 1 wherein said controller controls the adjustment of a far distance rearview mirror and a near distance rearview mirror.

5. The system of claim 1 wherein said system further includes a facial recognition system to recognize a selected driver and to adjust a rearview mirror to a driver's prior adjusted position.

6. The system of claim 5 wherein data utilized to recognize said driver is taken from at least one of a group of onboard storage, external storage, and cloud storage locations.

7. The system of claim 1 wherein said sensory system can identify the driver's head position and adjust at least one rearview mirror to a suggested position.

8. The system of claim 1 wherein said controller is cognizant of driver's head position and driver's seat position to adjust a rearview mirror to a suggested position.

9. The system of claim 8 wherein said controller is cognizant of at least one of a group of seat properties including seat forward/rearward position, seat height, seat tilt, seat back tilt to adjust a mirror to a suggested position.

10. The system of claim 1 wherein said sensory system includes determining the position of said driver's pupils with respect to driver's eye sclera to determine driver's intended mirror to adjust.

11. A system for adjusting rearview mirrors of an automotive vehicle, said vehicle having external driver side and external passenger side rearview mirrors, said system comprising:
a switch responsive to a vehicle operator's input for adjusting a rearview mirror;
a visual sensory system for determining driver's intended mirror to adjust;
a controller cognizant of driver's intended mirror to adjust, said mirror causing said intended mirror to respond to said switch input; and
a recognition system to identify said driver and to adjust said mirrors to driver's last adjusted position.

12. A method for adjusting rearview mirrors in an automotive vehicle comprising:
providing a switch allowing the vehicle operator to provide an input to adjust a rearview mirror;
sensing a driver's head position to determine the driver's intended mirror to adjust; and
making cognizant a controller of driver's intended mirror to adjust and causing said mirror to adjust to driver's switch input.

13. The method of claim 12 wherein said system is determining between driver's side external and passenger's side external rearview mirrors to adjust.

14. The method of claim 13 further including sensing an interior rearview mirror as driver's intended mirror to adjust.

15. The method of claim 12 further including facially recognizing a driver and adjusting at least one of said mirrors to driver's prior position.

16. The method of claim 15 retrieving data to said recognition system from a cloud storage, on board storage, or external storage data storage area to identify said driver and place the vehicle rear view mirrors at the driver pre-selected positions.

17. The method of claim 12 further including recognizing driver's head position and recognizing at least one of a group of driver's forward/rearward seat position, seat height, seat tilt or back tilt for determining a suggested adjusted position of a rearview mirror.

18. The method of claim 12 further including determining a position of a driver's eye pupils with respect to a driver's eye sclera to determine eye focus to determine driver's intended seat adjustment.
